(19) United States
(12) Patent Application Publication
(10) Pub. No.: US 2014/0057162 A1
(43) Pub. Date: Feb. 27, 2014

(54) GLASS CERAMIC THAT CONDUCTS LITHIUM IONS, AND USE OF SAID GLASS CERAMIC

(71) Applicants: Meike Schneider, Taunusstein (DE); Wolfgang Schmidbauer, Mainz (DE); Oliver Hochrein, Mainz (DE); Thomas Pfeiffer, Ingelheim (DE); Sonja Lauer, Bischofsheim (DE)

(72) Inventors: Meike Schneider, Taunusstein (DE); Wolfgang Schmidbauer, Mainz (DE); Oliver Hochrein, Mainz (DE); Thomas Pfeiffer, Ingelheim (DE); Sonja Lauer, Bischofsheim (DE)

(73) Assignee: SCHOTT AG, Mainz (DE)

(21) Appl. No.: 14/003,175

(22) PCT Filed: Feb. 2, 2012
(86) PCT No.: PCT/EP12/51750

§ 371 Date: Nov. 8, 2013

(30) Foreign Application Priority Data
Mar. 4, 2011 (DE) 10 2011 013 018.7

(51) Int. Cl. H01M 4/36; H01M 10/0525; H01M 10/0561

(52) U.S. Cl. CPC H01M 4/364; H01M 10/0561; H01M 10/0525
USPC 429/188; 252/182.1

(57) ABSTRACT

A glass ceramic is provided that has at least one crystal phase that conducts lithium ions and a total content of Ta₂O₅ of at least 0.5 wt. %. The glass ceramic finds utility as a component selected from the group consisting of a lithium ion battery, an electrolyte in a lithium ion battery, an electrode component in a lithium ion battery, an additive to a liquid electrolyte in a lithium ion battery, a coating on an electrode in a lithium ion battery, and combinations thereof.

The invention relates to glass-ceramics which conduct lithium ions and also their use, in particular in lithium ion batteries.

Rechargeable lithium ion batteries generally contain liquid electrolytes or polymer electrolytes. Such electrolytes can ignite in the case of overheating or leakage of the battery and thus represent a safety risk. Furthermore, the use of liquid electrolytes leads to undesirable secondary reactions at anode and cathode in the batteries, which can reduce the capacity and operating life of the batteries. At the same time, the energy density is limited in these batteries since the use of pure lithium metal as anode is not possible because of lack of chemical or electrochemical stability of the electrolytes. Instead, materials such as graphite into which lithium is intercalated are used, which leads to a lower energy density. An additional problem is that the cathode experiences large volume changes during charging and discharging, which leads to stresses in the composite.

These problems, viz. increasing safety, operating life and energy density of lithium ion batteries, could be solved by the use of solid-state electrolytes.

However, the solid-state electrolytes available at the present time in many cases have an unacceptably low ion conductivity or serious disadvantages in production and handling.

The documents DE 102007030604 A1 and US 2010/0047696 A1 propose the use of ceramic materials having crystal phases such as Li₇La₃Zr₂O₁₂, Li₇₊ₓAₓG₃₋ₓZrO₁₂ (A: divalent cation, G: trivalent cation). These materials are usually produced by a solid-state reaction. A disadvantage of this production route is that the resulting materials generally have a residual porosity which can have an adverse effect on lithium ion conduction. Furthermore, the residual porosity makes the production of a gastight electrolyte, as would be necessary, for example, for use in a lithium-air cell, difficult.

An alternative to ceramic materials is provided by glass-ceramics, in the case of which a starting glass is firstly melted and hot-formed (e.g. cast). The starting glass is, in a second step, either ceramicized directly (“bulk glass-ceramic”) or as powder (“sintered glass-ceramic”).

In ceramicization, controlled crystallization can occur as a result of an appropriately selected temperature-time profile and this allows setting of a microstructure of the glass-ceramic which is optimized for lithium ion conductivity. In this way, an improvement in the conductivity in the order of more than a factor of 10 can be achieved.

Various glass-ceramics which conduct lithium ions are known. Mention may firstly be made of sulfidic glass-ceramic compositions such as Li—S—P, Li₂S—B₂S₃—Li₄SiO₄ or Li₂S—P₂S₅—P₂O₅, and secondly oxidic glass-ceramics.

The sulfidic compositions Li—S—P and Li₂S—P₂S₅—P₂O₅ are sometimes produced by milling of the starting materials under protective gas and subsequent heat treatment (likewise generally under protective gas). The production of Li—P—S glass-ceramics is described in the documents US 20050107239 A1, US 2009159839 A, JP 2008120666A.

Li₂S—P₂S₅—P₂O₅ can as reported by A. Hayashi et al., Journal of Non-Crystalline Solids 355 (2009) 1919-1923, be produced both via a milling operation and via the melt. Glass-ceramics from the system Li₂S—B₂S₃—Li₄SiO₄ can also be produced via the melt route and subsequent quenching; these process steps, too, have to be carried out in the absence of air (see US 2009011339 A and Y. Seino et al., Solid State Ionics 177 (2006) 2601-2603). The lithium ion conductivities which can be achieved are from 2×10⁻⁴ to 6×10⁻³ S/cm at room temperature.

However, production under protective gas and sometimes complicated milling operations make the production of these sulfidic glass-ceramics expensive. In addition, handling and storage frequently also have to be carried out under protective gas or at least in a water-free environment, which can represent a significant disadvantage for the production of lithium batteries.

The glass-ceramics based on oxidic systems, on the other hand, are simpler and therefore cheaper to produce and have a higher chemical stability. Known glass-ceramics of this type are mainly phosphate-based compositions having crystal phases having a crystal structure similar to NASICON (Sodium Superionic Conductor).

US 20030205467 A1 describes the production of glass-ceramics having the main crystal phase Li₍₁₊ₓ₎(Al, Ga)ₓTi₍₂₋ₓ₎(PO₄)₃ (0<x≦0.8) from P₂O₅, TiO₂, SiO₂, M₂O₃ (M=Al or Ga) and Li₂O. After crystallization, an ion conductivity of from 0.6 to 1.5×10⁻³ S/cm was achieved. The starting glasses are very susceptible to crystallization and have to be quenched on a metal plate in order to avoid uncontrolled crystallization. This limits the possibilities for shaping and setting the microstructure in the glass-ceramic.

In the documents U.S. Pat. No. 6,030,909 and U.S. Pat. No. 6,485,622, GeO₂ and ZrO₂ are additionally introduced into the glass-ceramic. GeO₂ increases the glass formation range and reduces the tendency for crystallization to occur. In practice, however, this positive effect is limited by the high raw materials price of germanium. ZrO₂, on the other hand, leads to an increase in crystallization. The starting glasses mentioned in these documents also tend to undergo uncontrolled crystallization and generally have to be quenched in order to obtain a suitable starting glass. In Electrochem. Commun., 6 (2004) 1233-1237 and in Materials Letters, 58 (2004), 3428-3431, Xu et al. describe Li₂O—Cr₂O₃—P₂O₅ glass-ceramics which likewise have high conductivities of from 5.7×10⁻⁴ to 6.8×10⁻⁴ S/cm. However, these starting glasses also have to be quenched because of the strong tendency to undergo crystallization.

Glass-ceramics which contain Fe₂O₃ have also been described (K. Nagamine et al., Solid State Ionics, 179 (2008) 508-515). Here, ion conductivities of 3×10⁻⁶ S/cm were found. However, the use of iron (or other polyvalent elements) frequently leads to electrical conductivity which has to be avoided in a solid-state electrolyte. This glass-ceramic is, according to JP 2008047412 A, therefore preferably used as cathode material since electrical conductivity is desirable here in order to aid contacting of the cathode.

Proceeding from this prior art, it is an object of the invention to discover and produce glass-ceramics which conduct lithium ions and at room temperature have a lithium ion conductivity of preferably at least 10⁻⁶ S/cm and preferably have a low electrical conductivity. Starting glasses suitable for conversion (ceramicization) into glass-ceramics according to the invention should have a sufficient crystallization stability so they can preferably be produced from a glass melt by hot forming, in particular by casting, without the necessity for quenching. At the same time, both the glass-ceramics and the starting glasses should have sufficient chemical stability in air, so that problem-free storage is possible.

Furthermore, the glass-ceramics of the invention should preferably be able to be used in lithium ion batteries and also be able to be obtained by alternative production processes such as ceramicization and sintering of starting glass powders.

According to the invention, this object is achieved according to claim 1 by a glass-ceramic, wherein the glass-ceramic contains at least one crystal phase which conducts lithium ions and the glass-ceramic has a total content of Ta₂O₅ of at least 0.5% by weight.

Preferred embodiments of the glass-ceramic of the invention are described below.

The glass-ceramic preferably has a lithium ion conductivity at 25° C. of greater than 10⁻⁶ S/cm.

The glass-ceramic preferably has an electrical conductivity at 25° C. of less than 10⁻⁹ S/cm, in particular less than 10⁻¹⁰ S/cm.

The measured density of the glass-ceramic is preferably at least 90%, in particular at least 95%, of the theoretical density.

The crystal phase which conducts lithium ions in the glass-ceramic preferably consists essentially of an Li compound which is isostructural with NASICON or contains such a compound. The Li compound is, in particular, Li_{1+x-y}M⁵⁺_{y}M³⁺ₓM⁴⁺_{2-x-y}(PO₄)₃, where x and y are in the range from 0 to 1, (1+x−y)>1 and M is a cation having a valence of +3, +4 or +5.

M⁵⁺ is preferably Ta⁵⁺ and/or Nb⁵⁺, M³⁺ is preferably Al³⁺, Cr³⁺, Ga³⁺ and/or Fe⁺ and/or M⁴⁺ is preferably Ti⁴⁺, Zr⁴⁺, Si⁴⁺ and/or Ge⁴⁺.

The glass-ceramic preferably has at least one of the following composition components in % by weight:

| | |
|---|---|
| Al₂O₃ | from 0 to 20, preferably from 4 to 18, |
| | particularly preferably from 6 to 15.5, |
| GeO₂ | from 0 to 38, preferably <20, |
| | particularly preferably <10, |
| Li₂O | from 2 to 12, preferably from 4 to 8, |
| P₂O₅ | from 30 to 55, |
| TiO₂ | from 0 to 35, |
| ZrO₂ | from 0 to 16, |
| SiO₂ | from 0 to 15, |
| Cr₂O₃ + Fe₂O₃ | from 0 to 15, |
| Ga₂O₃ | from 0 to 15, |
| Ta₂O₅ | from 0.5 to 36.5, |
| Nb₂O₅ | from 0 to 30, |
| Halides | <5, preferably <3, particularly |
| | preferably <0.3, |
| M₂O | <1, preferably <0.1 (where M is an |
| | alkali metal cation apart from Li⁺) |

and also further constituents, e.g. refining agents or
fluxes, from 0 to 10% by weight.

The glass-ceramic is preferably obtained from a starting glass produced from a glass melt, with the starting glass displaying negligible crystallization during hot forming of the starting glass. Negligible crystallization is present, in particular, when the starting glass which can be converted into the glass-ceramic is X-ray-amorphous.

Furthermore, the glass-ceramic is preferably obtained from a starting glass which has been milled to a powder and subsequently converted by means of a thermal sintering process into the glass-ceramic.

The glass-ceramic of the invention is preferably used as constituent of a lithium ion battery, preferably a rechargeable lithium ion battery, as electrolyte in a lithium ion battery, as part of an electrode in a lithium ion battery, as additive to a liquid electrolyte in a lithium ion battery or as coating on an electrode in a lithium ion battery.

Glass-ceramics according to the invention which have at least one crystal phase which conducts lithium ions and a total content of at least 0.5% by weight of Ta₂O₅ are particularly well suited to achieving the object of the invention because the content of Ta₂O₅ significantly improves the crystallization stability of the starting glass.

Furthermore, Ta₂O₅ can, because it can be incorporated into the crystal phase which conducts lithium ions, have a positive effect on the lithium ion conductivity of the glass-ceramic as a result of the proportion of crystal phase which conducts lithium ions increasing. However, the specific conductivity of the glass-ceramic (of the electrolyte) at the same time plays a smaller role since better shaping (which is simplified in the case of a lower tendency for crystallization to occur) allows the production of thinner electrolyte films, resulting in the total resistance of the electrolyte decreasing.

The incorporation of Ta₂O₅ additionally has a positive effect on the conductivity of the crystal phase, which can be improved further by optimizing the Ta₂O₅/Al₂O₃ ratio and/or the Ta₂O₅/TiO₂ ratio.

A further advantage of the use of tantalum oxide is the significantly reduced mix costs compared to germanium oxide. The raw materials costs of Ta₂O₅ are about a third of the costs for GeO₂, which for the first time makes economical production of a solid-state electrolyte composed of glass-ceramic possible.

The glass-ceramics preferably contain from 0.5 to 30% by weight of Ta₂O₅, particularly preferably from 0.5 to 20% by weight of Ta₂O₅.

As main crystal phase of the glass-ceramic, Li_{1+x-y}M³⁺ₓM⁴⁺_{2-x-y}M⁵⁺_{y}(PO₄)₃ having a NASICON structure, where M⁵⁺ can be Ta and optionally Nb, M³⁺ can be Al, Cr, Ga, Fe and M⁴⁺ can be Ti, Zr, Si, Ge, is generally preferably formed.

The lithium present here serves as ion conductor and therefore has to be present in a sufficient concentration (at least 2% by weight, better at least 4% by weight, of Li₂O) in the glass-ceramic. However, an excessively high concentration of more than 12% by weight brings no advantages in respect of the lithium ion conductivity and can impair the chemical stability of the glass-ceramic.

Phosphorus oxide is added as glass former and also forms the basic skeleton of the crystal phase of the glass-ceramic. Here, compositions containing from 30 to 55% by weight of P₂O₅ have been found to have a positive effect.

Germanium oxide improves the stability of the starting glass and is built into the crystal phase of the glass-ceramic. This positive effect is counterbalanced by the high raw materials costs which make economical production appear to be questionable at more than 30% by weight of GeO₂.

Aluminum oxide acts as network transformer and is incorporated in combination with the pentavalent oxides of tantalum and niobium into the crystal phase.

Titanium oxide and zirconium oxide can also be incorporated into the crystal phase. In the case of titanium oxide in particular, the positive influence on the ion conductivity is known. However, both oxides promote crystallization, so that the amount thereof should be limited. Furthermore, in the case of TiO₂ there can be the problem that possible reduction of Ti⁴⁺ to Ti³⁺ can reduce the electrochemical stability and possibly lead to electrical conductivity, which is undesirable when the glass-ceramic is used as electrolyte.

The addition of up to 15% by weight of SiO₂ can have a positive influence on glass formation, but foreign phases which do not conduct ions frequently occur at relatively high contents, which reduces the total conductivity of the glass-ceramic.

The use of chromium oxide and iron oxide which can likewise be incorporated into the crystal phase is possible. However, as in the case of TiO₂, the amount should be limited so as to retain the electrochemical stability of the glass-ceramic and in the case of use as electrolyte avoid electrical conductivity.

On the other hand, if the glass-ceramic is to be used as constituent of electrodes, electrical conductivity of the glass-ceramic is desirable in order to simplify outward conduction of current.

The use of Ga₂O₃ has an effect analogous to that of Al₂O₃, but only rarely brings advantages because of the higher raw materials costs.

As further components, the glass-ceramic of the invention can contain other constituents, e.g. conventional refining agents and fluxes such as As₂O₃, Sb₂O₃ in the usual amounts of up to 10% by weight, preferably up to 5% by weight. Further impurities which are “brought in” with the conventional industrial raw materials should not exceed 1% by weight, preferably 0.5% by weight.

The glass-ceramic can contain up to 5% by weight of halides, preferably less than 3% by weight, in order to improve the melting behavior of the starting glasses. However, particular preference is given to essentially halogen-free compositions, since vaporization of halides during the melting process of the starting glasses is undesirable for reasons of environmental protection and occupational hygiene.

The glass-ceramic should, in order to avoid introduction of undesirable alkali metal ions into the lithium battery, contain less than 1% by weight of other alkali metal oxides (apart from lithium oxide), preferably less than 0.1% by weight of other alkali metal oxides.

For the purposes of the present patent application, a glass-ceramic is a material which is, starting out from a starting glass produced by melting, converted in a controlled manner by means of a targeted heat treatment into a glass-ceramic (having a glass phase and a crystal phase). This does not include materials which have a similar composition and have been produced by solid-state reactions.

The glass-ceramic can be produced either directly by ceramicization of a starting glass (bulk starting glass) or by ceramicization and sintering and/or pressing of starting glass powder.

The ability of the starting glasses to be able to be produced without spontaneous crystallization during casting is also advantageous for the sintering process, since, in contrast to glass powder which is already partially crystalline, glass powder which is not crystalline or has a very low crystalline proportion enables a dense sintered glass-ceramic to be produced.

The glass-ceramics according to the invention can be used as electrolyte in rechargeable lithium ion batteries, particularly in solid-state lithium ion batteries. For this purpose, they can be used either as thin layer or membrane as sole electrolyte or as constituent of the electrolyte together with other material (e.g. mixed with a polymer or an ionic liquid). To produce such a layer or membrane, it is possible to use not only the possible methods of shaping a starting glass (casting, drawing, rolling, floating, etc.) but also techniques such as screen printing, tape casting or coating techniques.

Use as coating on an electrode, e.g. applied by means of sputtering processes or CVD processes, is also possible. Furthermore, the glass-ceramic can also be used as additive to the electrode (e.g. mixed with an electronically conductive material). Use as separator in a cell filled with liquid electrolyte is also conceivable.

### EXAMPLES

The invention is illustrated with the aid of the examples summarized in the table.

The individual starting glasses having the compositions shown in the table were melted at from 1500 to 1650° C. in a fused silica crucible and cast to produce flat cast blocks (thickness from about 3 to 8 mm, diameter from 30 to 40 mm). These starting glass blocks were subsequently annealed at a temperature below the glass transition temperature T_{g} and slowly cooled to room temperature. The starting glasses were firstly assessed visually for the occurrence of crystallization and in case of doubt examined by means of X-ray diffraction (XRD). The starting glasses according to the invention displayed negligible crystallization after casting; they were all X-ray-amorphous. For the purposes of the present invention, X-ray-amorphous means that a starting glass sample displays no sign of crystallization in the form of reflections in the XRD measurement. This generally corresponds to less than 1% by volume of crystal phase in the starting glass sample.

Specimens for conductivity measurements (round disks having a diameter of 20 mm and a thickness of 1 mm), XRD measurements and in part density determinations were produced from the starting glasses.

After nucleation in the temperature range from 500° C. to 600° C. for from 0 to 4 hours, the starting glasses were ceramicized (i.e. converted into glass-ceramics) at maximum temperatures of from 620 to 850° C. and holder times of from 6 to 12 hours.

The nucleation and ceramicization temperatures used were determined by means of a DTA measurement (heating rate 5 K/min).

The conductivity was measured on Cr/Ag-coated specimens by means of frequency- and temperature-dependent impedance measurements in the range from 10⁻² to 10⁷ Hz and from 25 to 350° C.

The examples denoted by an asterisk (*) in the table are comparative examples.

Glass-ceramics which conduct lithium ions described in the literature display either a strong tendency to undergo devitrification, i.e. the starting glasses can generally be produced in vitreous form only by quenching (as can be seen from comparative examples 6* to 8*) or they contain considerable amounts (>37% by weight) of GeO₂, which makes production much more expensive (example 5*). Examples 1 and 2 show that it is possible to replace the germanium content by tantalum oxide without impairing the lithium ion conductivity. Since the price of Ta₂O₅ is very much lower than that of GeO₂, the production costs can be reduced in this way.

In example 3, the proportion of GeO₂ was decreased further and once again a high ion conductivity of more than 10⁻⁶ S/cm was measured.

Comparison of these examples shows that although the conductivity is initially reduced compared to the tantalum-free sample example 5*, it subsequently remains in the range from 5×10⁻⁶ S/cm to 10⁻⁵ S/cm independently of the remaining germanium content.

The literature describes the use of titanium oxide as an alternative way of reducing the proportion of germanium (comparative examples 5*, 6* and 8*). However, this leads to the starting glasses crystallizing even during casting. Example 4 illustrates the positive effect of tantalum oxide. Although this glass, too, contains more than 16% by weight of TiO₂, it can be produced in vitreous form without quenching. At the same time, the glass-ceramic produced therefrom has an ion conductivity of 2.2×10⁻⁵ S/cm and is, since it does not contain any germanium, inexpensive to produce.

The glass-ceramic of the invention can also be produced as sintered glass-ceramic. For this purpose, the starting glass, as described above, was melted and shaped by means of a ribbon machine. Here, the liquid glass is poured onto cooled metal rollers and processed to produce glass ribbons. These glass ribbons were subsequently milled in isopropanol. The resulting glass powder was dried on a rotary evaporator and cold isostatically pressed. The compacts were then ceramicized in a manner analogous to the above-described samples and characterized by means of impedance measurements. The conductivities measured on these samples were in the order of magnitude of from 10⁻⁶ to 10⁻⁵ S/cm, which shows that the glass-ceramics of the invention can also be produced via a sintering process.

Thus, for example, a melt having the same composition as example 4 was produced as described above. Part of the glass ribbons were firstly ceramicized (850° C./12 h) and then milled. Another part were milled without prior ceramicization to give glass powder. A comparable particle size of d₅₀=0.4 μm was measured on both powders.

Compacts were subsequently produced from the two powders and sintered at 850° C./12 h. The conductivity of the specimen produced from the vitreous material was 1×10⁻⁶ S/cm, while the specimen produced from the ceramicized material had a conductivity of 8.5×10⁻⁶ S/cm.

TABLE
(Examples of glass-ceramics according to
the invention and comparative examples)

| | Example 1 | Example 2 | Example 3 | Example 4 |
|---|---|---|---|---|
| Al₂O₃ | 5.98 | 5.89 | 4.93 | 5.35 |
| GeO₂ | 36.33 | 35.27 | 25.98 | — |
| Li₂O | 5.61 | 5.52 | 4.81 | 5.22 |
| P₂O₅ | 49.98 | 49.19 | 42.31 | 45.91 |
| Ta₂O₅ | 2.1 | 4.13 | 21.97 | 23.17 |
| TiO₂ | — | — | — | 16.41 |
| SiO₂ | — | — | — | 3.94 |
| Appearance | clear | clear | white, | dark |
| of the | | | demixed | (violet) |
| starting | | | | |
| glass | | | | |
| DTA peak | 623.6° C. | 620.5° C. | 660.6° C. | 699.7° C., |
| | | | | 745.4° C. |
| Ceramiciza- | 550° C./4 h + | 550° C./4 h + | 550° C./4 h + | 550° C./4 h + |
| tion | 620° C./12 h | 620° C./12 h | 700° C./12 h | 745° C./12 h |
| Density of | 3.2216 g/cm³ | 3.2 g/cm³ | 3.4757 g/cm³ | 3.1963 g/cm³ |
| the glass- | | | | |
| ceramic | | | | |
| Conduc- | 6.16 × 10⁻⁶ | 1.06 × 10⁻⁵ | 5.71 × 10⁻⁶ | 1.8 × 10⁻⁵ |
| tivity of | S/cm | S/cm | S/cm | S/cm |
| the glass- | | | | |
| ceramic at | | | | |
| 25° C. | | | | |
| Crystal | Li(Ge, Ta)₂ | Li(Ge, Ta)₂ | Li(Ge, Ta)₂ | LiTi₂(PO₄)₃ |
| phase | (PO₄)₃ | (PO₄)₃ | (PO₄)₃, | |
| | | | TaPO₅ | |
| Ceramiciza- | 850° C./12 h | 850° C./12 h | 850° C./12 h | 850° C./12 h |
| tion | | | | |
| Conduc- | 1.1 × 10⁻⁴ | 1.5 × 10⁻⁴ | 1 × 10⁻⁵ | 2.2 × 10⁻⁵ |
| tivity of | S/cm | S/cm | S/cm | S/cm |
| the glass- | | | | |
| ceramic at | | | | |
| 25° C. | | | | |

| | Example 5* | Example 6* | Example 7* | Example 8* |
|---|---|---|---|---|
| Al₂O₃ | 6.08 | 8.13 | 8.06 | 9.26 |
| GeO₂ | 37.43 | 16.69 | — | — |
| Li₂O | 5.7 | 4.47 | 4.72 | 4.22 |
| P₂O₅ | 50.79 | 52.37 | 52.37 | 55.87 |
| Ta₂O₅ | — | — | — | — |
| TiO₂ | — | 15.94 | 32 | 30.64 |
| SiO₂ | — | 2.4 | 2.85 | — |
| Appearance | clear | crystal- | crystal- | crystal- |
| of the | | lizes | lizes | lizes |
| starting | | during | during | during |
| glass | | casting, | casting | casting, |
| | | partially | | violet |
| | | vitreous | | |
| DTA peak | 612.1° C. | 649.9° C. | 1069.9° C., | 691.6° C.; |
| | | | 1231.4° C., | 777.8° C. |
| | | | 1323.9° C. | |
| Ceramiciza- | 850° C./12 h | 900° C./12 h | 900° C./12 h | 950° C./12 h |
| tion | | | | |
| Density of | n.d. | specimen | n.d. | n.d. |
| the glass- | | porous | | |
| ceramic | | | | |
| Conduc- | 1.64 × 10⁻⁴ | not able to | 6.17 × 10⁻⁶ | 5.99 × 10⁻⁶ |
| tivity of | S/cm | be prepared | S/cm | S/cm |
| the glass- | | | | |
| ceramic at | | | | |
| 25° C. | | | | |
| Crystal | n.d. | Li(Ti, Ge)₂ | LiTi₂ | LiTi₂(PO₄)₃, |
| phase | | (PO₄)₃, | (PO₄)₃ | AlPO₄ |
| | | anatase | | |
| | Example 5* | Example 6* | Example 7* | Example 8* |
| Al₂O₃ | 6.08 | 8.13 | 8.06 | 9.26 |
| GeO₂ | 37.43 | 16.69 | — | — |
| Li₂O | 5.7 | 4.47 | 4.72 | 4.22 |
| P₂O₅ | 50.79 | 52.37 | 52.37 | 55.87 |
| Ta₂O₅ | — | — | — | — |
| TiO₂ | — | 15.94 | 32 | 30.64 |
| SiO₂ | — | 2.4 | 2.85 | — |
| Appearance | clear | crystal- | crystal- | crystal- |
| of the | | lizes | lizes | lizes |
| starting | | during | during | during |
| glass | | casting, | casting | casting, |
| | | partially | | violet |
| | | vitreous | | |
| DTA peak | 612.1° C. | 649.9° C. | 1069.9° C., | 691.6° C.; |
| | | | 1231.4° C., | 777.8° C. |
| | | | 1323.9° C. | |
| Ceramiciza- | 850° C./12 h | 900° C./12 h | 900° C./12 h | 950° C./12 h |
| tion | | | | |
| Density of | n.d. | specimen | n.d. | n.d. |
| the glass- | | porous | | |
| ceramic | | | | |
| Conduc- | 1.64 × 10⁻⁴ | not able to | 6.17 × 10⁻⁶ | 5.99 × 10⁻⁶ |
| tivity of | S/cm | be prepared | S/cm | S/cm |
| the glass- | | | | |
| ceramic at | | | | |
| 25° C. | | | | |
| Crystal | n.d. | Li(Ti, Ge)₂ | LiTi₂ | LiTi₂(PO₄)₃, |
| phase | | (PO₄)₃, | (PO₄)₃ | AlPO₄ |
| | | anatase | | |
| | Example 9 | Example 10 | Example 11 | Example 12 |
| Al₂O₃ | 6.68 | 6.67 | 5.38 | 4.88 |
| GeO₂ | — | — | — | — |
| Li₂O | 4.9 | 5.38 | 5.78 | 4.77 |
| P₂O₅ | 43.02 | 42.95 | 46.15 | 41.93 |
| Ta₂O₅ | 28.95 | 28.91 | 23.3 | 31.75 |
| TiO₂ | 12.76 | 15.35 | 16.49 | 13.07 |
| SiO₂ | 3.69 | 0.74 | 2.9 | 3.6 |
| Appearance | violet | violet | violet | violet |
| of the | | | | |
| starting | | | | |
| glass | | | | |
| DTA peak | 726.5° C., | 721° C., | 697.1° C. | 740.7° C. |
| | 789.7° C. | 857° C. | | |
| Ceramiciza- | 800° C./12 h | 860° C./12 h | 850° C./12 h | 850° C./12 h |
| tion | | | | |
| Conduc- | 1.5 × 10⁻⁵ | 2.3 × 10⁻⁶ | 3.1 × 10⁻⁵ | 3.2 × 10⁻⁵ |
| tivity of | S/cm | S/cm | S/cm | S/cm |
| the glass- | | | | |
| ceramic at | | | | |
| 25° C. | | | | |
| Ceramiciza- | 900° C./12 h | — | — | 900° C./12 h |
| tion | | | | |
| Conduc- | 3.8 × 10⁻⁵ | — | — | 2.7 × 10⁻⁵ |
| tivity of | S/cm | | | S/cm |
| the glass- | | | | |
| ceramic at | | | | |
| 25° C. | | | | |

| | Example 13 | Example 14 |
|---|---|---|
| Al₂O₃ | 5.40 | 4.93 |
| GeO₂ | — | — |
| Li₂O | 5.27 | 4.81 |
| P₂O₅ | 46.35 | 42.31 |
| Ta₂O₅ | 23.40 | 21.36 |
| TiO₂ | 12.69 | 7.72 |
| SiO₂ | 6.89 | 18.86 |
| Appearance | violet | violet-gray |
| of the | | |
| starting | | |
| glass | | |
| DTA peak | 699.9° C. | n.d. |
| Ceramiciza- | 850° C./12 h | 850° C./12 h |
| tion | | |
| Conduc- | 4.7 × 10⁻⁶ | 2.2 × 10⁻⁷ |
| tivity of | S/cm | S/cm |
| the glass- | | |
| ceramic at | | |
| 25° C. | | |
| Ceramiciza- | 900° C./12 h | — |
| tion | | |
| Conduc- | 2.5 × 10⁻⁶ | — |
| tivity of | S/cm | |
| the glass- | | |
| ceramic at | | |
| 25° C. | | |

n.d. = not determined

1-9. (canceled)

10. A glass-ceramic, comprising at least one crystal phase which conducts lithium ions and a total content of Ta₂O₅ of at least 0.5% by weight.

11. The glass-ceramic as claimed in claim 10, wherein the glass-ceramic has a lithium ion conductivity at 25° C. of greater than 10⁻⁶ S/cm.

12. The glass-ceramic as claimed in claim 11, wherein the glass-ceramic further has an electrical conductivity at 25° C. of less than 10⁻⁹ S/cm.

13. The glass-ceramic as claimed in claim 10, wherein the glass-ceramic has an electrical conductivity at 25° C. of less than 10⁻⁹ S/cm.

14. The glass-ceramic as claimed in claim 10, wherein the glass-ceramic has a measured density of at least 90% of a theoretical density.

15. The glass-ceramic as claimed in claim 10, wherein the at least one crystal phase consists essentially of an Li compound that is isostructural with NaSICON.

16. The glass-ceramic as claimed in claim 10, wherein the at least one crystal phase comprises Li_{1+x-y}M⁵⁺_{y}M³⁺ₓM⁴⁺_{2-x-y}(PO₄)₃, where x and y are in the range from 0 to 1, (1+x−y)>1, and M is a cation having the valence +3, +4 or +5.

17. The glass-ceramic as claimed in claim 16, wherein M⁵⁺ is selected from the group consisting of Ta⁵⁺, Nb⁵⁺, and combinations thereof.

18. The glass-ceramic as claimed in claim 16, wherein M³⁺ is selected from the group consisting of Al³⁺, Cr³⁺, Ga³⁺, Fe³⁺, and combinations thereof.

19. The glass-ceramic as claimed in claim 16, wherein M⁴⁺ is selected from the group consisting of Ti⁴⁺, Zr⁴⁺, Si⁴⁺, Ge⁴⁺, and combinations thereof.

20. The glass-ceramic as claimed in any of the claim 10, wherein the glass-ceramic has at least one of the following composition components in % by weight:

| | |
|---|---|
| Al₂O₃ | from 0 to 20, |
| GeO₂ | from 0 to 38, |
| Li₂O | from 2 to 12, |
| P₂O₅ | from 30 to 55, |
| TiO₂ | from 0 to 35, |
| ZrO₂ | from 0 to 16, |
| SiO₂ | from 0 to 15, |
| Cr₂O₃ + Fe₂O₃ | from 0 to 15, |
| Ga₂O₃ | from 0 to 15, |
| Ta₂O₅ | from 0.5 to 36.5, |
| Nb₂O₅ | from 0 to 30, |
| Halides | <5, and |
| M₂O | <1, where M is an alkali metal cation apart from Li⁺. |

21. The glass-ceramic as claimed in any of the claim 20, further comprising refining agents or fluxes from 0 to 10% by weight.

22. The glass-ceramic as claimed in any of the claim 20, wherein the glass-ceramic has, in % by weight, Al₂O₃ from 4 to 18.

23. The glass-ceramic as claimed in any of the claim 20, wherein the glass-ceramic has, in % by weight, Al₂O₃ from 6 to 15.5.

24. The glass-ceramic as claimed in any of the claim 20, wherein the glass-ceramic has, in % by weight, GeO₂<20.

25. The glass-ceramic as claimed in any of the claim 20, wherein the glass-ceramic has, in % by weight, GeO₂<10.

26. The glass-ceramic as claimed in any of the claim 20, wherein the glass-ceramic has, in % by weight, Li₂O from 4 to 8.

27. The glass-ceramic as claimed in any of the claim 20, wherein the glass-ceramic has, in % by weight, Halides<3.

28. The glass-ceramic as claimed in any of the claim 20, wherein the glass-ceramic has, in % by weight, Halides<0.3.

29. The glass-ceramic as claimed in any of the claim 20, wherein the glass-ceramic has, in % by weight, M₂O<0.1.

30. The glass-ceramic as claimed in claim 10, wherein the glass-ceramic displays negligible crystallization during hot forming.

31. The glass-ceramic as claimed in claim 10, wherein the glass-ceramic is a hot sintered glass-ceramic.

32. The glass-ceramic as claimed in claim 10, wherein the glass-ceramic is configured for use as a component selected from the group consisting of a lithium ion battery, an electrolyte in a lithium ion battery, an electrode in a lithium ion battery, an additive to a liquid electrolyte in a lithium ion battery, a coating on an electrode in a lithium ion battery, and combinations thereof.
